(19) United States
(12) Patent Application Publication
(10) Pub. No.: US 2015/0037560 A1
(43) Pub. Date: Feb. 5, 2015

(54) Pressure-sensitive adhesive

(71) Applicant: tesa SE, Hamburg (DE)

(72) Inventors: Thilo Dollase, Hamburg (DE); Anika Petersen, Bimohlen (DE); Michael Mayer, Hamburg (DE); Rolf Brix, Schmalfeld (DE)

(21) Appl. No.: 14/449,660

(22) Filed: Aug. 1, 2014

(30) Foreign Application Priority Data
Aug. 2, 2013 (DE) 10 2013 215 297.3

(51) Int. Cl. C09J 133/08

(52) U.S. Cl. CPC C09J 133/08
USPC 428/220; 525/93

(57) ABSTRACT

A pressure-sensitive adhesive is to achieve good bond strengths at both high and low temperatures. This aim is accomplished by the adhesive comprising the following components:

a) 40-70 wt %, based on the total weight of the adhesive, of at least one poly(meth)acrylate;
b) 15-50 wt %, based on the total weight of the adhesive, of at least one synthetic rubber; and
c) at least one tackifier compatible with the poly(meth)acrylate(s).

The invention further relates to an adhesive tape which comprises at least one layer of the pressure-sensitive adhesive of the invention.

The invention pertains to the technical field of pressure-sensitive adhesives as used in adhesive tapes. More particularly the invention proposes a pressure-sensitive adhesive based on polyacrylate and synthetic rubber and on a particular tackifier.

There are many sectors of technology where the use of adhesive tapes to join components is on the increase. It is frequently important that the material bonds produced in this way are preserved in the same quality even when they are exposed to extreme temperatures. The thermal influences include both heat and cold. Thus, it is conceivable that adhesive bonds mounted on the surfaces of cars, for example of decorative strips or brand symbols, have to withstand both winter frost temperatures and summer heat.

Specifically in the case of adhesive bonds on the surfaces of cars, a further difficulty which occurs results from the nonpolar nature of automobile surfaces. It is well known that high bond strengths are frequently unachievable or can be achieved only with very great difficulty on nonpolar substrates, for example polyethylene or polypropylene surfaces. The prior art for this purpose has often used adhesive compositions based on polymer mixtures.

U.S. Pat. No. 4,107,233 A describes an improvement to the adhesion to and to the printability of styrene-butadiene copolymers (SBC) by addition of polyacrylate.

EP 0 349 216 A1 describes an improvement to the low-temperature impact strength of pressure-sensitive polyacrylate adhesives by the addition of SBC, where 95 to 65 parts of polyacrylate are blended with 5 to 35 parts of SBC.

EP 0 352 901 A1 relates to pressure-sensitive adhesives which comprise 60 to 95 parts of a UV-polymerized polyacrylate and 35 to 5 parts of a synthetic rubber. This formulation improves the cold impact strength and the bonding to paints.

EP 0 437 068 A2 discloses cellular membranes with pressure-sensitive adhesive tacks that are based on polyacrylate/SBC blends and have improved cold impact strength.

WO 95/19393 A1 describes a blend of a styrene block copolymer modified with a carboxyl group and of a polyacrylate comprising at least one type of monomer containing nitrogen, where one objective of this technology is to improve the adhesive properties to low-energy substrates.

WO 2008/070386 A1 describes polymer blends which comprise at least 92 parts of an SBC-based adhesive and up to 10 parts of a polyacrylate component.

WO 2000/006637 A1 discloses blends of polyacrylates and SBC as a basis for foamed layers of adhesive.

In spite of the advanced knowledge gains documented in the prior art, an ongoing need exists for pressure-sensitive adhesives (PSAs) having pronounced efficiency in a very wide temperature range which includes both the low-temperature and high-temperature range.

It is an objective of the invention, therefore, to provide a pressure-sensitive adhesive which has good bonding performance in a temperature range from −30° C. to 70° C. and more particularly even at room temperature.

The achievement of this object is based on the concept of using, as a basis for the PSA, a mixture of polyacrylate and synthetic rubber and also a tackifier compatible with the polyacrylate. The invention accordingly first provides a pressure-sensitive adhesive which comprises:

a) 40-70 wt %, based on the total weight of the adhesive, of at least one poly(meth)acrylate;
b) 15-50 wt %, based on the total weight of the adhesive, of at least one synthetic rubber; and
c) at least one tackifier compatible with the poly(meth)acrylate(s). A PSA of this kind exhibits very good bond strength at room temperature and at −30° C. and 70° C., as has been shown by static and dynamic tests.

In line with the general understanding of the skilled person, a “pressure-sensitive adhesive” is understood to be a viscoelastic adhesive whose set, dry film at room temperature is permanently tacky and remains adhesive and can be bonded by gentle applied pressure to a multiplicity of substrates.

A “poly(meth)acrylate” is understood to be a polymer whose monomer basis consists to an extent of at least 60 wt % of acrylic acid, methacrylic acid, acrylic esters and/or methacrylic esters, with acrylic esters and/or methacrylic esters being present at least proportionally, preferably to an extent of at least 50 wt %, based on the overall monomer basis of the polymer in question. More particularly a “poly(meth)acrylate” is understood to be a polymer obtainable by radical polymerization of acrylic and/or methacrylic monomers and also, optionally, further, copolymerizable monomers.

In accordance with the invention the poly(meth)acrylate or poly(meth)acrylates is or are present at 40 to 70 wt %, based on the total weight of the PSA. The PSA of the invention preferably comprises 45 to 60 wt %, based on the total weight of the PSA, of at least one poly(meth)acrylate.

The glass transition temperature of the poly(meth)acrylates which can be used in accordance with the invention is preferably <0° C., more preferably between −20 and −50° C. The glass transition temperature of polymers or of polymer blocks in block copolymers is determined in the context of this invention by means of dynamic scanning calorimetry (DSC). This involves weighing out about 5 mg of an untreated polymer sample into an aluminium crucible (volume 25 μL) and closing the crucible with a perforated lid. Measurement takes place using a Netzsch DSC 204 F1. Operation takes place under nitrogen for inertization. The sample is first cooled to −150° C., then heated to +150° C. at a rate of 10 K/min, and cooled again to −150° C. The subsequent second heating plot is run again at 10 K/min, and the change in heat capacity is recorded. Glass transitions are recognized as steps in the thermogram.

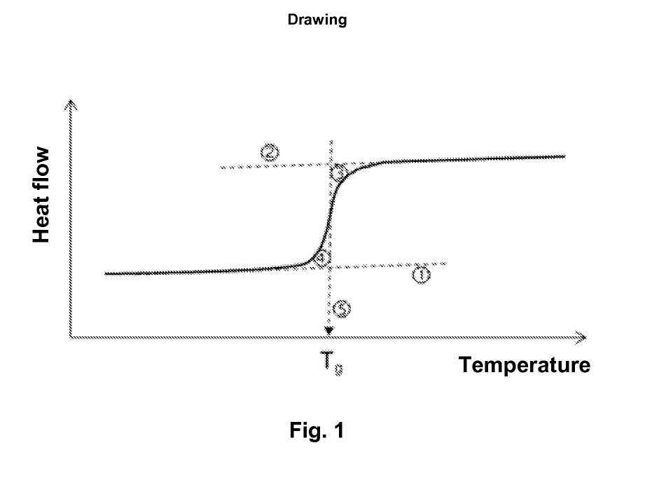

The glass transition temperature is obtained as follows (see FIG. 1):

The linear region of the measurement plot before and after the step is extended in the direction of increasing (region before the step) and falling (region after the step) temperatures, respectively. In the region of the step, a line of best fit \textcircled{5} is placed parallel with the ordinate so as to intersect the two extension lines, specifically so that two areas \textcircled{3} and \textcircled{4} (between in each case one of the extension lines, the line of best fit and the measurement plot) of equal content are formed. The point of intersection of the thus-positioned line of best fit with the measurement plot gives the glass transition temperature.

The poly(meth)acrylates of the PSA of the invention are obtainable preferably by at least proportional copolymerization of functional monomers which preferably are crosslinkable with epoxide groups. These monomers are more preferably those with acid groups (particularly carboxylic acid, sulphonic acid or phosphonic acid groups) and/or hydroxyl groups and/or acid anhydride groups and/or epoxide groups and/or amine groups; monomers containing carboxylic acid groups are especially preferred. It is very advantageous in particular if the polyacrylate features copolymerized acrylic acid and/or methacrylic acid. All of these groups have crosslinkability with epoxide groups, thereby making the polyacrylate amenable advantageously to thermal crosslinking with introduced epoxides.

Other monomers which may be used as comonomers for the poly(meth)acrylates, aside from acrylic and/or methacrylic esters having up to 30 C atoms per molecule, are, for example, vinyl esters of carboxylic acids containing up to 20 C atoms, vinylaromatics having up to 20 C atoms, ethylenically unsaturated nitriles, vinyl halides, vinyl ethers of alcohols containing 1 to 10 C atoms, aliphatic hydrocarbons having 2 to 8 C atoms and one or two double bonds, or mixtures of these monomers.

The properties of the poly(meth)acrylate in question may be influenced in particular by variation in the glass transition temperature of the polymer through different weight fractions of the individual monomers. The poly(meth)acrylate(s) of the invention may be traced back preferably to the following monomer composition:
a) acrylic esters and/or methacrylic esters of the following formula:

CH₂═C(R^{I})(COOR^{II})
where R^{I}═H or CH₃ and R^{II} is an alkyl radical having 4 to 14 C atoms,
b) olefinically unsaturated monomers having functional groups of the kind already defined for reactivity with preferably epoxide groups,
c) optionally further acrylates and/or methacrylates and/or olefinically unsaturated monomers which are copolymerizable with component (a).

The fractions of the corresponding components (a), (b), and (c) are preferably selected such that the polymerization product has a glass transition temperature of less than <0° C., more preferably between −20 and −50° C. (DSC). It is particularly advantageous to select the monomers of the component (a) with a fraction of 45 to 99 wt %, the monomers of component (b) with a fraction of 1 to 15 wt % and the monomers of component (c) with a fraction of 0 to 40 wt % (the figures are based on the monomer mixture for the “basic polymer”, in other words without additions of any additives to the completed polymer, such as resins etc).

The monomers of component (a) are more particularly plasticizing and/or non-polar monomers. Used preferably as monomers (a) are acrylic and methacrylic esters having alkyl groups consisting of 4 to 14 C atoms, more preferably 4 to 9 C atoms. Examples of such monomers are n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate and their branched isomers, such as isobutyl acrylate, isooctyl acrylate, isooctyl methacrylate, 2-ethylhexyl acrylate or 2-ethylhexyl methacrylate, for example.

The monomers of component (b) are more particularly olefinically unsaturated monomers having functional groups, more particularly having functional groups which are able to enter into a reaction with epoxide groups.

Used preferably for the component (b) are monomers having functional groups which are selected from the group encompassing the following: hydroxyl, carboxyl, sulphonic acid or phosphonic acid groups, acid anhydrides, epoxides, amines.

Particularly preferred examples of monomers of component (b) are acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, more particularly 2-hydroxyethyl acrylate, hydroxypropyl acrylate, more particularly 3-hydroxypropyl acrylate, hydroxybutyl acrylate, more particularly 4-hydroxybutyl acrylate, hydroxyhexyl acrylate, more particularly 6-hydroxyhexyl acrylate, hydroxyethyl methacrylate, more particularly 2-hydroxyethyl methacrylate, hydroxypropyl methacrylate, more particularly 3-hydroxypropyl methacrylate, hydroxybutyl methacrylate, more particularly 4-hydroxybutyl methacrylate, hydroxyhexyl methacrylate, more particularly 6-hydroxyhexyl methacrylate, allyl alcohol, glycidyl acrylate and glycidyl methacrylate.

In principle it is possible to use as component (c) all vinylically functionalized compounds which are copolymerizable with component (a) and/or with component (b). The monomers of component (c) may serve to adjust the properties of the resultant PSA.

Exemplary monomers of component (c) are as follows:

Methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxy acrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethylacrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethyl-aminopropylacrylamide, dimethylaminopropylmethacrylamide, N-(1-methyl-undecyl)acrylamide, N-(n-butoxymethyl)acrylamide, N-(butoxymethyl)methacrylamide, N-(ethoxymethyl)acrylamide, N-(n-octadecyl)acrylamide, and also N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, and vinyl isobutyl ether, vinyl esters, such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene, and macromonomers such as 2-polystyreneethyl methacrylate (weight-average molecular weight Mw, determined by means of GPC, of 4000 to 13000 g/mol), and poly(methyl methacrylate)ethyl methacrylate (Mw of 2000 to 8000 g/mol).

Monomers of component (c) may advantageously also be selected such that they include functional groups which support a subsequent radiation-chemical crosslinking (by electron beams or UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide and allyl acrylate.

The polyacrylates (“polyacrylates” are understood in the context of the invention to be synonymous with “poly(meth)acrylates”) may be prepared by methods familiar to the skilled person, especially advantageously by conventional radical polymerizations or controlled radical polymerizations. The polyacrylates may be prepared by copolymerization of the monomeric components using the customary polymerization initiators and also, optionally, chain transfer agents, the polymerization being carried out at the customary temperatures in bulk, in emulsion, for example in water or liquid hydrocarbons, or in solution.

Polyacrylates are prepared preferably by polymerization of the monomers in solvents, more particularly in solvents having a boiling range of 50 to 150° C., preferably of 60 to 120° C., using the customary amounts of polymerization initiators, which in general are 0.01 to 5, more particularly 0.1 to 2 wt % (based on the total weight of the monomers).

Suitable in principle are all customary initiators familiar to the skilled person. Examples of radical sources are peroxides, hydroperoxides and azo compounds, for example dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate and benzopinacol. One very preferred procedure uses as radical initiator 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Solvents suitable for preparing the poly(meth)acrylates include alcohols such as methanol, ethanol, n- and isopropanol, n- and isobutanol, preferably isopropanol and/or isobutanol, and also hydrocarbons such as toluene and more particularly petroleum spirits with a boiling range from 60 to 120° C. Further possibilities for use include ketones such as preferably acetone, methyl ethyl ketone and methyl isobutyl ketone, and esters such as ethyl acetate, and also mixtures of solvents of the type stated, with preference being given to mixtures which comprise isopropanol, more particularly in amounts of 2 to 15 wt %, preferably 3 to 10 wt %, based on the solvent mixture employed.

The preparation (polymerization) of the polyacrylates is followed preferably by a concentration procedure, and the further processing of the polyacrylates takes place with substantial absence of solvent. The concentration of the polymer may be effected in the absence of crosslinker and accelerator substances. Also possible, however, is the addition of one of these classes of compound to the polymer even prior to the concentration, so that the concentration then takes place in the presence of said substance(s).

The polymers can be transferred into a compounder after the concentration step. If appropriate, the concentration and the compounding may also take place in the same reactor.

The weight-average molecular weights M_{w} of the polyacrylates are preferably in a range from 20 000 to 2 000 000 g/mol; very preferably in a range from 100 000 to 1 500 000 g/mol, most preferably in a range from 150 000 to 1 000 000 g/mol. The figures for average molecular weight M_{w} and for polydispersity PD in this specification relate to the determination by gel permeation chromatography. For this purpose it may be advantageous to carry out the polymerization in the presence of suitable chain transfer agents such as thiols, halogen compounds and/or alcohols, in order to set the desired average molecular weight.

The figures for the number-average molar mass Mn and the weight-average molar mass Mw in this specification relate to the determination by gel permeation chromatography (GPC). The determination takes place on 100 μl of a sample which has undergone clarifying filtration (sample concentration 4 g/l). Tetrahydrofuran with 0.1 vol % of trifluoroacetic acid is used as eluent. The measurement is made at 25° C.

The preliminary column used is a PSS-SDV column, 5 μm, 10³ Å, 8.0 mm*50 mm (figures here and below in the following sequence: type, particle size, porosity, internal diameter*length; 1 Å=10⁻¹⁰ m). Separation takes place using a combination of columns of type PSS-SDV, 5 μm, 10³ Å and also 10⁵ Å and 10⁶ Å each with 8.0 mm*300 mm (columns from Polymer Standards Service; detection by means of Shodex RI71 differential refractometer). The flow rate is 1.0 ml per minute. Calibration for polyacrylates is made against PMMA standards (polymethyl methacrylate calibration) and for others (resins, elastomers) against PS standards (polystyrene calibration).

The polyacrylates preferably have a K value of 30 to 90, more preferably of 40 to 70, measured in toluene (1% strength solution, 21° C.). The K value according to Fikentscher is a measure of the molecular weight and of the viscosity of the polymer.

The principle of the method derives from the determination of the relative solution viscosity by capillary viscometry. For this purpose the test substance is dissolved in toluene by shaking for thirty minutes, to give a 1% strength solution. In a Vogel-Ossag viscometer at 25° C. the flow time is measured and is used to derive, in relation to the viscosity of the pure solvent, the relative viscosity of the sample solution. In accordance with Fikentscher, the K value (K=1000 k) can be read off from tables [P. E. Hinkamp, Polymer, 1967, 8, 381].

Particularly suitable in accordance with the invention are polyacrylates which have a narrow molecular weight distribution range (polydispersity PD<4). These materials in spite of a relatively low molecular weight after crosslinking have a particularly good shear strength. The relatively low polydispersity also facilitates processing from the melt, since the flow viscosity is lower than for a broader-range polyacrylate while application properties are largely the same. Narrow-range poly(meth)acrylates can be prepared advantageously by anionic polymerization or by controlled radical polymerization methods, the latter being especially suitable. Via N-oxyls as well it is possible to prepare such polyacrylates. Furthermore, advantageously, Atom Transfer Radical Polymerization (ATRP) may be employed for the synthesis of narrow-range polyacrylates, the initiator used comprising preferably monofunctional or difunctional secondary or tertiary halides and the halide(s) being abstracted using complexes of Cu, Ni, Fe, Pd, Pt, Ru, Os, Rh, Co, Ir, Ag or Au.

The monomers for preparing the poly(meth)acrylates preferably include proportionally functional groups suitable for entering into linking reactions with epoxide groups. This advantageously permits thermal crosslinking of the polyacrylates by reaction with epoxides. Linking reactions are understood to be, in particular, addition reactions and substitution reactions. Preferably, therefore, there is a linking of the building blocks carrying the functional groups to building blocks carrying epoxide groups, more particularly in the sense of a crosslinking of the polymer building blocks carrying the functional groups via linking bridges comprising crosslinker molecules which carry epoxide groups. The substances containing epoxide groups are preferably polyfunctional epoxides, in other words those having at least two epoxide groups; accordingly, the overall result is preferably an indirect linking of the building blocks carrying the functional groups.

The poly(meth)acrylates of the PSA of the invention are crosslinked preferably by linking reactions—especially in the sense of addition reactions or substitution reactions—of functional groups they contain with thermal crosslinkers. All thermal crosslinkers may be used which not only ensure a sufficiently long processing life, meaning that there is no gelling during the processing operation, particularly the extrusion operation, but also lead to rapid postcrosslinking of the polymer to the desired degree of crosslinking at temperatures lower than the processing temperature, more particularly at room temperature. Possible for example is a combination of carboxyl-, amino- and/or hydroxyl-containing polymers and isocyanates, more particularly aliphatic or trimerized isocyanates deactivated with amines, as crosslinkers.

Suitable isocyanates are, more particularly, trimerized derivatives of MDI [4,4′-methylene-di(phenyl isocyanate)], HDI [hexamethylene diisocyanate, 1,6-hexylene diisocyanate] and/or IPDI [isophorone diisocyanate, 5-isocyanato-1-isocyanatomethyl-1,3,3-trimethylcyclohexane], examples being the types Desmodur® N3600 and XP2410 (each BAYER AG: aliphatic polyisocyanates, low-viscosity HDI trimers). Likewise suitable is the surface-deactivated dispersion of micronized trimerized IPDI BUEJ 339®, now HF9® (BAYER AG).

Also suitable in principle for the crosslinking, however, are other isocyanates such as Desmodur VL 50 (MDI-based polyisocyanate, Bayer AG), Basonat F200WD (aliphatic polyisocyanate, BASF AG), Basonat HW100 (water-emulsifiable polyfunctional, HDI-based isocyanate, BASF AG), Basonat HA 300 (allophanate-modified polyisocyanate based on HDI isocyanurate, BASF) or Bayhydur VPLS2150/1 (hydrophilically modified IPDI, Bayer AG).

Preference is given to using thermal crosslinkers at 0.1 to 5 wt %, more particularly at 0.2 to 1 wt %, based on the total amount of the polymer to be crosslinked.

The poly(meth)acrylates of the PSA of the invention are crosslinked preferably by means of one or more epoxides or one or more substances containing epoxide groups. The substances containing epoxide groups are more particularly polyfunctional epoxides, in other words those having at least two epoxide groups; accordingly, the overall result is an indirect linking of the building blocks of the poly(meth)acrylates that carry the functional groups. The substances containing epoxide groups may be aromatic compounds and may be aliphatic compounds.

Outstandingly suitable polyfunctional epoxides are oligomers of epichlorohydrin, epoxy ethers of polyhydric alcohols (more particularly ethylene, propylene and butylene glycols, polyglycols, thiodiglycols, glycerol, pentaerythritol, sorbitol, polyvinyl alcohol, polyallyl alcohol and the like), epoxy ethers of polyhydric phenols [more particularly resorcinol, hydroquinone, bis(4-hydroxyphenyl)methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, bis(4-hydroxyphenyl)phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl)(4-chlorophenyl)methane, 1,1-bis(4-hydroxyphenyl)cyclohexane, bis(4-hydroxyphenyl)cyclohexylmethane, 4,4′-dihydroxybiphenyl, 2,2′-dihydroxybiphenyl, 4,4′-dihydroxydiphenyl sulfone] and also their hydroxyethyl ethers, phenol-formaldehyde condensation products, such as phenol alcohols, phenol aldehyde resins and the like, S- and N-containing epoxides (for example N,N-diglycidylaniline, N,N′-dimethyldiglycidyl-4,4-diaminodiphenylmethane) and also epoxides prepared by customary methods from polyunsaturated carboxylic acids or monounsaturated carboxylic esters of unsaturated alcohols, glycidyl esters, polyglycidyl esters, which may be obtained by polymerization or copolymerization of glycidyl esters of unsaturated acids or are obtainable from other acidic compounds (cyanuric acid, diglycidyl sulfide, cyclic trimethylene trisulfone and/or derivatives thereof, and others).

Very suitable ethers are, for example, 1,4-butanediol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, 1,6-hexanediol diglycidyl ether, polypropylene glycol diglycidyl ether, trimethylolpropane triglycidyl ether, bisphenol A diglycidyl ether and bisphenol F diglycidyl ether.

Particularly preferred for the poly(meth)acrylates as polymers to be crosslinked is the use of a crosslinker-accelerator system (“crosslinking system”) described for example in EP 1 978 069 A1, in order to gain more effective control over not only the processing life and crosslinking kinetics but also the degree of crosslinking. The crosslinker-accelerator system comprises at least one substance containing epoxide groups, as crosslinker, and at least one substance which has an accelerating effect on crosslinking reactions by means of epoxide-functional compounds at a temperature below the melting temperature of the polymer to be crosslinked, as accelerator.

Accelerators used in accordance with the invention are more preferably amines (to be interpreted formally as substitution products of ammonia; in the formulae below, these substituents are represented by “R” and encompass in particular alkyl and/or aryl radicals and/or other organic radicals), more especially preferably those amines which enter into no reactions or only slight reactions with the building blocks of the polymers to be crosslinked.

Selectable in principle as accelerators are primary (NRH₂), secondary (NR₂H) and tertiary (NR₃) amines, and also of course those which have two or more primary and/or secondary and/or tertiary amine groups. Particularly preferred accelerators, however, are tertiary amines such as, for example, triethylamine, triethylenediamine, benzyldimethylamine, dimethylaminomethylphenol, 2,4,6-tris-(N,N-dimethylamino-methyl)phenol and N,N′-bis(3-(dimethylamino)propyl)urea. As accelerators it is also possible with advantage to use polyfunctional amines such as diamines, triamines and/or tetramines. Outstandingly suitable are diethylenetriamine, triethylenetetramine and trimethylhexamethylenediamine, for example.

Used with preference as accelerators, furthermore, are amino alcohols. Particular preference is given to using secondary and/or tertiary amino alcohols, where in the case of two or more amine functionalities per molecule, preferably at least one, and preferably all, of the amine functionalities are secondary and/or tertiary. As preferred amino-alcohol accelerators it is possible to employ triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butylethanolamine, 2-[bis(2-hydroxyethyl)amino]-2-(hydroxymethyl)-1,3-propanediol, 1-[bis(2-hydroxyethyl)amino]-2-propanol, triisopropanolamine, 2-(dimethylamino)ethanol, 2-(diethylamino)ethanol, 2-(2-dimethylaminoethoxy)ethanol, N,N,N′-trimethyl-N′-hydroxyethyl bisaminoethyl ether, N,N,N′-trimethylaminoethylethanolamine and/or N,N,N′-trimethylaminopropyl-ethanolamine.

Other suitable accelerators are pyridine, imidazoles (such as, for example 2-methylimidazole) and 1,8-diazabicyclo[5.4.0]undec-7-ene. Cycloaliphatic polyamines as well may be used as accelerators. Suitable also are phosphate-based accelerators such as phosphines and/or phosphonium compounds, such as triphenylphosphine or tetraphenylphosphonium tetraphenylborate, for example.

The PSA of the invention further comprises at least one synthetic rubber. In accordance with the invention the synthetic rubber or rubbers is or are present in the PSA at 15 to 50 wt %, based on the total weight of the PSA. The PSA preferably comprises 20 to 40 wt % of at least one synthetic rubber, based in each case on the total weight of the PSA.

At least one synthetic rubber of the PSA of the invention is preferably a block copolymer having an A-B, A-B-A, (A-B)ₙX or (A-B-A)ₙX construction, in which
the blocks A independently of one another are a polymer formed by polymerization of at least one vinylaromatic;
the blocks B independently of one another are a polymer formed by polymerization of conjugated dienes having 4 to 18 C atoms and/or isobutylene, or are a partially or fully hydrogenated derivative of such a polymer;
X is the residue of a coupling reagent or initiator and
n is an integer 2.

In particular, all synthetic rubbers of the PSA of the invention are block copolymers having a construction as set out above. The PSA of the invention may therefore also comprise mixtures of different block copolymers having a construction as above.

Suitable block copolymers (vinylaromatic block copolymers) therefore comprise one or more rubberlike blocks B (soft blocks) and one or more glasslike blocks A (hard blocks). With particular preference at least one synthetic rubber of the PSA of the invention is a block copolymer having an A-B, A-B-A, (A-B)₃X or (A-B)₄X construction, where A, B and X have the definitions above. Very preferably all synthetic rubbers of the PSA of the invention are block copolymers having an A-B, A-B-A, (A-B)₃X or (A-B)₄X construction, wherein A, B and X have the definitions above. More particularly the synthetic rubber of the PSA of the invention is a mixture of block copolymers having an A-B, A-B-A, (A-B)₃X or (A-B)₄X construction, said mixture preferably comprising at least diblock copolymers A-B and/or triblock copolymers A-B-A.

The block A is generally a glasslike block having a preferred glass transition temperature (Tg, DSC), which is above room temperature. More preferably the Tg of the glasslike block is at least 40° C., more particularly at least 60° C., very preferably at least 80° C. and extremely preferably at least 100° C. The fraction of vinylaromatic blocks A in the overall block copolymers is preferably 10 to 40 wt %, more preferably 20 to 33 wt %. Vinylaromatics for the construction of the block A include preferably styrene, α-methylstyrene and/or other styrene derivatives. The block A may therefore take the form of a homopolymer or a copolymer. With particular preference the block A is a polystyrene.

The vinylaromatic block copolymer further generally has a rubberlike block B or soft block having a preferred Tg of less than room temperature. The Tg of the soft block is more preferably less than 0° C., more particularly less than −10° C., for example less than −40° C. and very preferably less than −60° C.

Preferred conjugated dienes as monomers for the soft block B are selected in particular from the group consisting of butadiene, isoprene, ethyl butadiene, phenyl butadiene, piperylene, pentadiene, hexadiene, ethyl hexadiene, dimethyl butadiene and the farnesene isomers, and also any desired mixtures of these monomers. The block B as well may take the form of a homopolymer or a copolymer.

With particular preference the conjugated dienes as monomers for the soft block B are selected from butadiene and isoprene. For example, the soft block B is a polyisoprene, a polybutadiene or a partially or fully hydrogenated derivative of one of these two polymers, such as polybutylene-butadiene in particular; or is a polymer of a mixture of butadiene and isoprene. Very preferably the block B is a polybutadiene.

The PSA of the invention further comprises at least one tackifier which is compatible with the poly(meth)acrylate(s), and which may also be referred to as a bond strength booster or tackifier resin. In line with the general understanding of the skilled person, a “tackifier” is understood to be an oligomeric or polymeric resin which raises the autohesion (the tack or inherent stickiness) of the PSA by comparison with a PSA devoid of tackifier but otherwise identical.

A “tackifier compatible with the poly(meth)acrylate(s)” is understood to be a tackifier which has the effect on the system obtained after thorough mixing of poly(meth)acrylate and tackifier of changing its glass transition temperature by comparison with the pure poly(meth)acrylate, it also being possible to assign only one Tg to the mixture of poly(meth)acrylate and tackifier. In the system obtained after thorough mixing of poly(meth)acrylate and tackifier, a tackifier that was not compatible with the poly(meth)acrylate(s) would result in two Tgs, one assignable to the poly(meth)acrylate and the other to the resin domains. In this connection, the Tg is determined calorimetrically by means of DSC (differential scanning calorimetry).

The poly(meth)acrylate-compatible resins of the composition of the invention preferably have a DACP of less than 0° C., very preferably of not more than −20° C., and/or preferably an MMAP of less than 40° C., very preferably of not more than 20° C. With regard to the determination of DACP and MMAP values, reference is made to C. Donker, PSTC Annual Technical Seminar, Proceedings, pp. 149-164, May 2001.

With preference in accordance with the invention the tackifier compatible with the poly(meth)acrylates is a terpene-phenolic resin or a rosin derivative, more preferably a terpene-phenolic resin. The PSA of the invention may also comprise mixtures of two or more tackifiers. Among the rosin derivatives, rosin esters are preferred.

The PSA of the invention comprises preferably from 7 to 25 wt %, based on the total weight of the PSA, of at least one tackifier compatible with the poly(meth)acrylates. With particular preference the tackifier or tackifiers compatible with the poly(meth)acrylates is or are present at 12 to 20 wt %, based on the total weight of the PSA.

The tackifier or tackifiers compatible with the poly(meth)acrylates in the PSA of the invention are preferably also compatible, or at least partly compatible, with the synthetic rubber, more particularly with its soft block B, the above definition of the term “compatible” applying correspondingly. Polymer/resin compatibility is dependent on factors including the molar mass of the polymers and/or resins. The lower the molar mass(es), the better the compatibility. For a given polymer it may be the case that the low molecular mass constituents in the resin molar mass distribution are compatible with the polymer, while those of higher molecular mass are not. This is an example of partial compatibility.

The weight ratio of poly(meth)acrylates to synthetic rubbers in the PSA of the invention is preferably from 1:1 to 3:1, more particularly from 1.8:1 to 2.2:1.

The weight ratio of tackifiers compatible with the poly(meth)acrylates to synthetic rubbers in the PSA of the invention is preferably at most 2:1, more particularly at most 1:1. This weight ratio is preferably at least 1:4.

The PSA of the invention very preferably comprises

a) 50-60 wt %, based on the total weight of the PSA, of at least one poly(meth)acrylate;
b) 20-40 wt %, based on the total weight of the PSA, of at least one synthetic rubber; and
c) 7-25 wt % of at least one tackifier compatible with the poly(meth)acrylate(s).

Within the PSA of the invention the synthetic rubber is preferably in dispersion in the poly(meth)acrylate. Accordingly, poly(meth)acrylate and synthetic rubber are preferably each homogeneous phases. The poly(meth)acrylates and synthetic rubbers present in the PSA are preferably selected such that at 23° C. they are not miscible with one another to the point of homogeneity. At least microscopically and at least at room temperature, therefore, the PSA of the invention preferably has at least two-phase morphology. More preferably, poly(meth)acrylate(s) and synthetic rubber(s) are not homogeneously miscible with one another in a temperature range from 0° C. to 50° C., more particularly from −30° C. to 80° C. and so in these temperature ranges, at least microscopically, the PSA is present in at least two-phase form.

For the purposes of this specification, components are defined as being “not homogeneously miscible with one another” when even after intimate mixing, the formation of at least two stable phases is detectable physically and/or chemically, at least microscopically, with one phase being rich in one component and the second phase being rich in the other component. The presence of negligibly small amounts of one component in the other, without opposing the development of the multi-phase character, is considered immaterial in this context. Hence the poly(meth)acrylate phase may contain small amounts of synthetic rubber and/or the synthetic rubber phase may contain small amounts of poly(meth)acrylate component, as long as these amounts are not substantial amounts which influence phase separation.

Phase separation may be realized in particular such that discrete regions (“domains”) which are rich in synthetic rubber—in other words are essentially formed of a synthetic rubber—are present in a continuous matrix which is rich in poly(meth)acrylate—in other words is essentially formed of poly(meth)acrylate. One suitable system of analysis for a phase separation is scanning electron microscopy, for example. Alternatively, phase separation may be detected, for example, by the different phases having two glass transition temperatures, independent of one another, on differential scanning calorimetry (DSC). Phase separation is present in accordance with the invention when it can clearly be shown by at least one of the analytical techniques.

Additional multi-phasedness may also be present as a fine structure within the synthetic rubber-rich domains, with the A blocks forming one phase and the B blocks forming a second phase.

The PSA of the invention may comprise, over and above the constituents detailed so far, one or more hydrocarbon resin(s) that are incompatible with the poly(meth)acrylate. Hydrocarbon resins of this kind, which are likewise tackifiers, preferably include hydrogenated polymers of dicyclopentadiene; unhydrogenated, partially hydrogenated, selectively hydrogenated or fully hydrogenated hydrocarbon resins based on C5, C5/C9 or C9 monomer streams, and polyterpene resins based on α-pinene and/or β-pinene and/or δ-limonene. The hydrocarbon resins preferably have a DACP value of at least 0° C., very preferably of at least 20° C., and/or preferably an MMAP value of at least 40° C., very preferably of at least 60° C. With regard to the determination of DACP and MMAP values, reference is made to C. Donker, PSTC Annual Technical Seminar, Proceedings, p. 149-164, May 2001. The aforementioned hydrocarbon resins may be present in the PSA either individually or in a mixture. Particularly preferred hydrocarbon resins are polyterpene resins based on α-pinene and/or β-pinene and/or β-limonene.

The PSA of the invention is preferably foamed. Foaming may take place by means of any chemical and/or physical methods. Preferably, however, a foamed PSA of the invention is obtained by the introduction and subsequent expansion of microballoons. “Microballoons” are understood to be hollow microspheres which are elastic and therefore expandable in their basic state, having a thermoplastic polymer shell. These spheres are filled with low-boiling liquids or with liquefied gas. Shell material used includes, in particular, polyacrylonitrile, PVDC, PVC or polyacrylates. Suitable low-boiling liquid includes, in particular, hydrocarbons of the lower alkanes, such as isobutane or isopentane, for example, which are enclosed in the form of liquefied gas under pressure in the polymer shell.

As a result of exposure of the microballoons, more particularly exposure to heat, the outer polymer shell undergoes softening. At the same time, the liquid propellant gas present within the shell undergoes transition to its gaseous state. At this point, the microballoons undergo an irreversible and three-dimensional expansion. Expansion is at an end when the internal pressure matches the external pressure. Since the polymeric shell is retained, a closed-cell foam is obtained accordingly.

If foaming is carried out using microballoons, the microballoons may be supplied to the formulation in the form of a batch, paste or extended or unextended powder. Conceivable metering points are, for example, before or after the point of addition of the poly(meth)acrylate, for instance together as a powder with the synthetic rubber or as a paste at a later point in time.

A multiplicity of types of microballoon are available commercially, and differ essentially in their size (6 to 45 μm diameter in the unexpanded state) and in the initiation temperatures they require for expansion (75 to 220° C.). One example of commercially available microballoons are the Expancel® DU products (DU=dry unexpanded) from Akzo Nobel. Unexpanded microballoon products are also available as an aqueous dispersion with a solids fraction or microballoon fraction at about 40 to 45 wt %, and also, moreover, as polymer-bonded microballoons (master batches), for example in ethyl vinyl acetate with a microballoon concentration of about 65 wt %. Not only the microballoon dispersions but also the master batches, like the DU products, are suitable for producing a foamed PSA of the invention.

A foamed PSA of the invention may also be produced with so-called pre-expanded microballoons. With this group, the expansion takes place prior to mix incorporation into the polymer matrix. Pre-expanded microballoons are available commercially for example under the designation Dualite® or with the type designation DE (Dry Expanded).

The density of a foamed PSA of the invention is preferably 200 to 1000 kg/m³, more preferably 300 to 900 kg/m³, more particularly 400 to 800 kg/m³.

Depending on the area of application and desired properties of the PSA of the invention, it may be admixed with other components and/or additives, in each case alone or in combination with one or more further additives or components.

Thus, for example, the PSA of the invention may comprise fillers, dyes and pigments in powder and granule form, including abrasive and reinforcing versions, such as chalks (CaCO₃), titanium dioxide, zinc oxide and/or carbon blacks, for example.

The PSA preferably comprises one or more forms of chalk as filler, more preferably Mikrosöhl chalk (from Söhlde). In preferred fractions of up to 20 wt %, the addition of filler causes virtually no change to the technical adhesive properties (shear strength at room temperature, instantaneous bond strength to steel and PE). Furthermore, different organic fillers may be included.

Suitable additives for the PSA of the invention further include—selected independently of other additives—non-expandable hollow polymer beads, solid polymer beads, hollow glass beads, solid glass beads, hollow ceramic beads, solid ceramic beads and/or solid carbon beads (“Carbon Micro Balloons”).

The PSA of the invention may additionally comprise low-flammability fillers, for example ammonium polyphosphate; electrically conductive fillers, for example conductive carbon black, carbon fibres and/or silver-coated beads; thermally conductive materials such as, for example, boron nitride, aluminium oxide, silicon carbide; ferromagnetic additives, for example iron(III) oxides; organic renewable raw materials such as, for example, wood flour, organic and/or inorganic nanoparticles, fibres; compounding agents, ageing inhibitors, light stabilizers and/or anti-ozonants.

Plasticizers may optionally be included. Plasticizers added may be, for example, (meth)acrylate oligomers, phthalates, cyclohexanedicarboxylic esters, water-soluble plasticizers, plasticizer resins, phosphates or polyphosphates.

The addition of silicas, advantageously of precipitated silica surface-modified with dimethyldichlorosilane, may be utilized in order to adjust the thermal shear strength of the PSA.

A method for producing a PSA of the invention may initially comprise a procedure of concentrating the polyacrylate solution or dispersion resulting from polymer preparation. Concentration of the polymer may be effected in the absence of crosslinker and accelerator substances. It is, however, also possible to add not more than one of these substances to the polymer prior to concentration, with the concentration then taking place in the presence of this or these substance(s).

The synthetic rubber may be added together with the poly(meth)acrylate-compatible resin by a solids metering facility into a compounder. Via a side feeder, the concentrated and optionally already melted poly(meth)acrylate can be introduced into the compounder. In particular versions of the process it is also possible for concentration and compounding to take place in the same reactor. The poly(meth)acrylate-compatible resins may also be supplied via a resin melt and a further side feeder at a different position in the process, such as following introduction of synthetic rubber and poly(meth)acrylate, for example.

Further additives and/or plasticizers may likewise be supplied as solids or a melt or else a batch in combination with another formulation component.

The compounder used may in particular be an extruder. In the compounder, the polymers are preferably in the melt, either since they are introduced already in the melt state or because they are heated to the melt state in the compounder. The polymers are advantageously maintained in the melt state within the compounder by heating.

If accelerator substances for the crosslinking of the poly(meth)acrylate are employed, they are preferably not added to the polymers until shortly before further processing, in particular prior to coating or other forms of shaping. The time window of the addition prior to coating is guided in particular by the pot life that is available, in other words the processing life in the melt, without deleterious changes to the properties of the resulting product.

The crosslinkers, epoxides, for example, and the accelerators may also both be added shortly before the further processing of the composition, in other words, advantageously, in the phase as set out above for the accelerators. For this purpose it is advantageous if crosslinkers and accelerators are introduced into the operation simultaneously at the same location, optionally in the form of an epoxide/accelerator blend. In principle it is also possible to switch the times and locations of addition for crosslinkers and accelerators in the versions set out above, so that the accelerator may be added before the crosslinker substances.

After the material has been compounded, it may be further-processed, more particularly by coating onto a permanent or temporary carrier. A permanent carrier remains joined to the layer of adhesive in the application, while the temporary carrier is removed from the layer of adhesive in the ongoing processing operation, for example in the converting of the adhesive tape, or in the application.

Coating of the self-adhesive compositions may take place with hot melt coating nozzles known to the skilled person or, preferably, with roll applicator mechanisms, also called coating calenders. The coating calenders may consist advantageously of two, three, four or more rolls.

Preferably at least one of the rolls is provided with an anti-adhesive roll surface. With preference all rolls of the calender that come into contact with the PSA are anti-adhesively surfaced. Employed preferably as an anti-adhesive roll surface is a steel-ceramic-silicone composite. Such roll surfaces are resistant to thermal and mechanical loads.

It has emerged as being particularly advantageous if roll surfaces are used that have a surface structure, more particularly such that the surface does not make complete contact with the layer of composition being processed, the area of contact instead being smaller by comparison with a smooth roll. Particularly favourable are structured rolls such as engraved metal rolls—engraved steel rolls, for example.

The invention further provides an adhesive tape which comprises at least one layer of a PSA of the invention. The PSAs of the invention are particularly suitable for the formation of high layer thicknesses. The thickness of the front layer of a PSA of the invention is therefore preferably 100 μm to 5000 μm, more preferably 150 μm to 3000 μm, more particularly 200 μm to 2500 μm, for example 500 μm to 2000 μm.

The adhesive tape of the invention preferably consists of a layer of a PSA of the invention. In this case, therefore, the tape is what is called an adhesive transfer tape. The PSA may alternatively take the form of a carrier layer of a single-sided or double-sided adhesive tape, or may form at least one of the pressure-sensitively adhesive outer layers of a carrier-comprising single-sided or double-sided adhesive tape. In the present context, a release liner, of the kind customarily applied to PSAs to provide them with (temporary) protection, is not considered a constituent of an adhesive tape. Accordingly, the adhesive tape of the invention may consist solely of a layer of a PSA of the invention, even if said layer is lined with a release liner.

### EXAMPLES

### Test Methods

### Test 1: 90° Steel Bond Strength

The bond strength to steel was determined under test conditions of 23° C.+/−1° C. temperature and 50%+/−5% relative humidity. The specimens were cut to a width of 20 mm and adhered to a steel plate. The test plate was cleaned and conditioned prior to the measurement. This was done by wiping the steel plate first with acetone and leaving it to lie in the air for a subsequent 5 minutes to allow the solvent to evaporate. The side of the single-layer adhesive tape facing away from the test substrate was then lined with 36 μm etched PET film, thereby preventing the specimen from stretching during the measurement. This was followed by the roller application of the test specimen to the steel substrate. For this purpose, a 4 kg roller was rolled five times back and forth over the tape with a rolling speed of 10 m/min. 20 minutes after this roller application, the steel plate was inserted into a special mount that allows the specimen to be peeled off vertically upwards at an angle of 90°. The bond strength was measured using a Zwick tensile testing machine. The results of the measurement are reported in N/cm as averages of three individual measurements.

Bond strengths above 15 N/cm are regarded as good values; values above 20 N/cm are preferred. Values above 25 N/cm are regarded as very good.

### Test 2: Static Shear Test at 70° C.

An adhesive transfer tape of dimensions 13×20 mm was bonded between two cleaned steel plates. The bond was pressed down at 0.260 kN for one minute. After storage for 3 days, the assembly was suspended on a shear test measuring station combined with a heating cabinet. The load was 5 N. The test was considered to be complete when the bond failed or the set test time had elapsed. The result is reported in min and is the mean value from 3 individual measurements.

Good values are regarded as times above 200 min; values above 1000 min are preferred. Values above 5000 min are regarded as very good.

### Test 3: Dynamic L Jig at Room Temperature and −30° C.

The method which follows was used to ascertain the detachment force for double-sided adhesive tapes subjected to an edge load at one end. An L-shaped jig was bonded to a test specimen cut into a square (edge length 25 mm) on a cleaned and conditioned ABS sheet. The bond was pressed at 60 N for 5 seconds. After a peel increase time of 24 h at 23° C. and 50% relative air humidity, the L jig was subjected to pulling with a tensile tester at a speed of 300 mm/min. For the test temperature of −30° C., the tensile tester was encased with a suitable climate-controlled chamber. The test specimens were equilibrated at −30° C. for at least 30 min before the measurement was conducted.

The result is the mean value from 3 individual measurements.

Good values, both at room temperature and at −30° C., are regarded as forces above 60 N/cm; values above 75 N/cm are preferred. Values above 100 N/cm are regarded as very good.

### Preparation of Polyacrylate Base Polymer:

A reactor conventional for radical polymerizations was charged with 72.0 kg of 2-ethylhexyl acrylate, 20.0 kg of methyl acrylate, 8.0 kg of acrylic acid and 66.6 kg of acetone/isopropanol (94:6). After nitrogen gas had been passed through it for 45 minutes with stirring, the reactor was heated to 58° C. and 50 g of AIBN in solution in 500 g of acetone were added. The external heating bath was then heated to 75° C. and the reaction was carried out constantly at this external temperature. After one hour a further 50 g of AIBN in solution in 500 g of acetone were added, and after 4 hours the batch was diluted with 10 kg of acetone/isopropanol mixture (94:6).

After 5 hours and again after 7 hours, portions of 150 g of bis-(4-tert-butylcyclohexyl)peroxydicarbonate, in each case in solution in 500 g of acetone, were added for re-initiation. After a reaction time of 22 hours, the polymerization was discontinued and the batch was cooled to room temperature. The product had a solids content of 55.8% and was dried. The resulting polyacrylate had a K value of 58.9, an average molecular weight of Mw=748 000 g/mol, a polydispersity D (Mw/Mn) of 8.9 and a static glass transition temperature of Tg=−35.2° C.

### Example 1

In a planetary roller extruder, the synthetic rubber Kraton D1118 in granule form was melted via a solids metering facility. This was followed by addition of a microballoon paste (50% Expancel 051DU40 in Ethomeen C25). Via a side feeder, the polyacrylate base polymer was fed in, having been melted in a single-screw extruder, and a terpene-phenolic resin (Dertophen DT105) was metered in. The mixture was admixed with a solution of crosslinker (Polypox R16, 15% in Rheofos RDP) and accelerator (15% Epicure 925 in Rheofos RDP). The melt was stirred and, using a double-roll calender, coated between two release films (siliconized PET film). This gave a single-layer adhesive tape having a layer thickness of 1000 μm and a density of 550 kg/m³. Its composition was 48% polyacrylate, 25% Kraton D1118, 18% Dertophen DT105, 4% crosslinker/accelerator solution (crosslinker:accelerator=1:1), and 5% microballoon paste (figures in wt %).

### Example 2

In a planetary roller extruder, the synthetic rubber Kraton D1118 in granule form was melted via a solids metering facility. Via a side feeder, the polyacrylate base polymer was fed in, having been melted in a single-screw extruder. Subsequently, a terpene-phenolic resin (Dertophen DT105) was metered in. The mixture was transferred into a twin-screw extruder and admixed therein with a solution of crosslinker (Polypox R16 30% in Rheofos RDP) and accelerator (30% Epicure 925 in Rheofos RDP). This was followed by the addition of a microballoon paste (50% Expancel 051DU40 in Ethomeen C25). The melt was stirred and, using a double-roll calender, coated between two release films (siliconized PET film). This gave a single-layer adhesive tape having a layer thickness of 1200 μm and a density of 730 kg/m³. Its composition was 41% polyacrylate, 35% Kraton D1118, 15% Dertophen DT105, 4% crosslinker/accelerator solution (crosslinker:accelerator=1:1), 5% microballoon paste (figures in wt %).

### Example 3

The procedure of Example 1 was repeated. This gave a single-layer adhesive tape having a layer thickness of 1000 μm and a density of 540 kg/m³. Its composition was 53% polyacrylate, 23% Kraton D1118, 15% Dertophen T105, 4% crosslinker/accelerator solution (crosslinker:accelerator=1:1), and 5% microballoon paste (figures in wt %).

### Example 4

The procedure of Example 1 was repeated. This gave a single-layer adhesive tape having a layer thickness of 1000 μm and a density of 570 kg/m³. Its composition was 45.5% polyacrylate, 28% Kraton D1102, 15% Dertophen T105, 2.5% Piccolyte A115, 4% crosslinker/accelerator solution (crosslinker:accelerator=1:1), and 5% microballoon paste (figures in wt %).

### Example 5

The procedure of Example 1 was repeated. This gave a single-layer adhesive tape having a layer thickness of 1000 μm and a density of 570 kg/m³. Its composition was 48% polyacrylate, 28% Kraton D1118, 7.5% Dertophen T105, 7.5% Piccolyte A115, 4% crosslinker/accelerator solution (crosslinker:accelerator=1:1), and 5% microballoon paste (figures in wt %).

### Example 6

The procedure of Example 2 was repeated. This gave a single-layer adhesive tape having a layer thickness of 1000 μm and a density of 750 kg/m³. Its composition was 43% polyacrylate, 28% Kraton D1118, 20% Dertophen T105, 4% crosslinker/accelerator solution (crosslinker:accelerator=1:1), and 5% microballoon paste (figures in wt %).

### Example 7

The procedure of Example 1 was repeated. This gave a single-layer adhesive tape having a layer thickness of 1000 μm and a density of 570 kg/m³. Its composition was 45.5% polyacrylate, 28% Kraton D1102, 17.5% Dertophen T105, 4% crosslinker/accelerator solution (crosslinker:accelerator=1:1), and 5% microballoon paste (figures in wt %).

### Comparative Example 1

Via a side feeder, the polyacrylate base polymer was fed into a planetary roller extruder, having been melted in a single-screw extruder. Subsequently, a terpene-phenolic resin (Dertophen DT110) was metered in. The mixture was transferred into a twin-screw extruder and admixed therein with crosslinker and accelerator components (Polypox R16/Epicure 925). This was followed by the addition of a microballoon paste (50% Expancel 051DU40 in Ethomeen C25). Using a double-roll calender, the melt was coated between two release films (siliconized PET film). This gave a single-layer adhesive tape having a layer thickness of 1200 μm and a density of 870 kg/m³. Its composition was 71% polyacrylate, 29% Dertophen DT110, 0.3% crosslinker/accelerator, 2% microballoon paste (figures in wt %).

### Comparative Example 2

The procedure was analogous to example 1. This gave a single-layer adhesive tape having a layer thickness of 1000 μm and a density of 600 kg/m³. Its composition was 48.5% polyacrylate, 7.5% Kraton D1118, 16% Dertophen T105, 19% Piccolyte A115, 4% crosslinker/accelerator solution (crosslinker:accelerator=1:1), 5% microballoon paste (figures in wt %).

### Comparative Example 3

The procedure was analogous to example 1. This gave a single-layer adhesive tape having a layer thickness of 1000 μm and a density of 650 kg/m³. Its composition was 49% acrylate, 27% Kraton D1118, 15% Piccolyte A115, 4% crosslinker/accelerator solution (crosslinker:accelerator=1:1), 5% microballoon paste (figures in wt %).

TABLE 1
Test results

| | Bond | | | | |
|---|---|---|---|---|---|
| | strength | L jig (room | L jig | Static shear test | |
| | (steel, 90°) | temperature) | (−30° C.) | (5 N, 70° C.) | |
| Example 1 | 28 N/cm | 89 N/cm | 96 N/cm | >5000 | min |
| Example 2 | 29 N/cm | 75 N/cm | 91 N/cm | >5000 | min |
| Example 3 | 30 N/cm | 93 N/cm | 91 N/cm | 2355 | min |
| Example 4 | 18 N/cm | 107 N/cm | 148 N/cm | 250 | min |
| Example 5 | 30 N/cm | 75 N/cm | 106 N/cm | >5000 | min |
| Example 6 | 27 N/cm | 95 N/cm | 62 N/cm | 1150 | min |
| Example 7 | 18 N/cm | 79 N/cm | 79 N/cm | 455 | min |
| Comparative | 31 N/cm | 137 N/cm | 7 N/cm | 114 | min |
| Example 1 | | | | | |
| Comparative | 35 N/cm | 125 N/cm | 22 N/cm | 31 | min |
| Example 2 | | | | | |
| Comparative | 23 N/cm | 73 N/cm | 54 N/cm | >5000 | min |
| Example 3 | | | | | |

1. A pressure-sensitive adhesive comprising:
a) 40-70 wt %, based on the total weight of the adhesive, of at least one poly(meth)acrylate;
b) 15-50 wt %, based on the total weight of the adhesive, of at least one synthetic rubber; and
c) at least one tackifier compatible with the poly(meth)acrylate(s).

2. The pressure-sensitive adhesive according to claim 1, wherein the weight ratio of poly(meth)acrylates to synthetic rubbers is from 1:1 to 3:1.

3. The pressure-sensitive adhesive according to claim 1 wherein the weight ratio of tackifiers compatible with the poly(meth)acrylates to synthetic rubbers is at most 2:1.

4. The pressure-sensitive adhesive according to claim 1 wherein the weight ratio of tackifiers compatible with the poly(meth)acrylates to the synthetic rubbers is at least 1:4.

5. The pressure-sensitive adhesive according to claim 1 wherein the synthetic rubber is a block copolymer having an A-B, A-B-A, (A-B)ₙ, (A-B)ₙX or (A-B-A)ₙX construction,
in which
the blocks A independently of one another are a polymer formed by polymerization of at least one vinylaromatic;
the blocks B independently of one another are a polymer formed by polymerization of conjugated dienes having 4 to 18 C atoms and/or isobutylene, or are a partially or fully hydrogenated derivative of such a polymer;
X is the residue of a coupling reagent or initiator and
n is an integer ≧2.

6. The pressure-sensitive adhesive according to claim 5, wherein the weight fraction of the blocks A, based on all block copolymers present in the adhesive, is 10 to 40 wt %.

7. The pressure-sensitive adhesive according to claim 1 wherein the tackifier compatible with the poly(meth)acrylates is a terpene-phenolic resin or a rosin derivative.

8. The pressure-sensitive adhesive according to claim 1 wherein the adhesive is foamed.

9. An adhesive tape comprising at least one layer of a pressure-sensitive adhesive according to claim 1.

10. The adhesive tape according to claim 9, wherein the thickness of the layer is 100 μm to 5000 μm.

11. The adhesive tape according to claim 9 wherein the adhesive tape comprises a layer of a pressure-sensitive adhesive according to claim 1.
